(19) United States
(12) Patent Application Publication
(10) Pub. No.: US 2025/0219529 A1
(43) Pub. Date: Jul. 3, 2025

(54) POWER CONVERSION CIRCUIT AND CONTROL SYSTEM

(71) Applicant: FLOSFIA INC., Kyoto (JP)

(72) Inventors: Takashi SHINOHE, Kyoto (JP); Shinpei MATSUDA, Kyoto (JP); Yasushi HIGUCHI, Kyoto (JP); Hideo MATSUKI, Nisshin-shi Aichi (JP); Hiroki WATANABE, Nisshin-shi Aichi (JP); Takashi KANEMURA, Nisshin-shi Aichi (JP)

(21) Appl. No.: 19/080,322

(22) Filed: Mar. 14, 2025

Related U.S. Application Data
(63) Continuation-in-part of application No. PCT/JP2023/033806, filed on Sep. 15, 2023.

(30) Foreign Application Priority Data
Sep. 15, 2022 (JP) 2022-147447

(51) Int. Cl. H02M 1/32; H02M 7/537

(52) U.S. Cl. CPC H02M 1/32; H02M 7/537

(57) ABSTRACT

Provided is a power conversion circuit including at least a switching element, and a control unit that detects a short-circuit state of the switching element and performs an off operation of the switching element based on a detection result, wherein the switching element includes a gallium oxide-based semiconductor, and the control unit controls the off operation of the switching element so that a time from occurrence of the short circuit to the off operation is less than 1.4 μsec.

### CROSS REFERENCE TO RELATED APPLICATION

This application is a continuation-in-part application of International Patent Application No. PCT/JP2023/033806 (Filed on Sep. 15, 2023), which claims the benefit of priority from Japanese Patent Application No. 2022-147447 (filed on Sep. 15, 2022).

The entire contents of the above applications, which the present application is based on, are incorporated herein by reference.

### 1. FIELD OF THE INVENTION

The present disclosure relates to a power conversion circuit and a control system.

### 2. DESCRIPTION OF THE RELATED ART

Semiconductor devices using wide bandgap gallium oxide (Ga₂O₃) are attracting attention as next-generation switching elements that may achieve high voltage resistance, low loss, and high heat resistance, and their application in power semiconductor devices such as inverters and converters is anticipated. Moreover, application as light-emitting and light-receiving devices such as LEDs and sensors are also anticipated due to the wide bandgap. It is known that mixed with indium or aluminum solely or in combination to form a mixed crystal, gallium oxide is controllable in terms of band gaps, constituting a very attractive family of material as InAlGaO-based semiconductors. Here, InAlGaO-based semiconductors indicate In_{X}Al_{Y}Ga_{Z}O₃ (0≤X≤2, 0≤Y≤2, 0≤Z≤2, X+Y+Z=1.5 to 2.5) and may be regarded as a family of materials including gallium oxide.

It is also known that wide bandgap semiconductor devices (either silicon carbide, gallium nitride, gallium oxide, or diamond, or any combination of these) are used in part or in whole for diodes or switching elements in a switching section of AC-DC conversion devices. In addition, it is described that α-Ga₂O₃ undergoes a phase transition to the most stable phase, β-Ga₂O₃, when annealed at temperatures exceeding 600° C.

### SUMMARY OF THE INVENTION

According to an example of the present disclosure, there is provided a power conversion circuit including at least a switching element, and a control unit that detects a short-circuit state of the switching element and performs an off operation of the switching element based on a detection result, wherein the switching element includes a gallium oxide-based semiconductor, and the control unit controls the off operation of the switching element so that a time from occurrence of the short circuit to the off operation is less than 1.4 μsec.

According to an example of the present disclosure, there is provided a power conversion circuit including at least a switching element, and a control unit that detects an abnormal state of the switching element and performs an off operation of the switching element based on a detection result, wherein the switching element includes a gallium oxide-based semiconductor, and the control unit controls the off operation of the switching element so that the gallium oxide-based semiconductor does not undergo a phase transition.

According to an example of the present disclosure, there is provided a power conversion circuit including at least a switching element, and a control unit that detects an abnormal state of the switching element and performs an off operation of the switching element based on a detection result, wherein the switching element includes a gallium oxide-based semiconductor, and the control unit controls the off operation of the switching element so that a temperature of the gallium oxide-based semiconductor does not exceed 600° C.

Thus, in a power conversion circuit of the present disclosure, it is possible to operate a circuit while utilizing the characteristics of gallium oxide-based semiconductors.

### BRIEF DESCRIPTION OF THE DRAWINGS

FIG. 1 is a block diagram illustrating an example of a control system according to an embodiment of the present disclosure.

FIG. 2 is a circuit diagram illustrating an example of the control system according to the embodiment of the present disclosure.

FIG. 3 is a diagram illustrating an example of an inverter drive device according to the embodiment of the present disclosure.

FIG. 4 is a schematic cross-sectional view illustrating an example of a metal-oxide-semiconductor field-effect transistor (MOSFET) used in the embodiment of the present disclosure.

FIG. 5 is a diagram illustrating a simulation circuit in the embodiment of the present disclosure.

FIG. 6 is a diagram illustrating the time variation of a gate voltage in simulation of gate voltage control.

FIG. 7 is a diagram illustrating the results of simulation conducted in a test example.

FIG. 8 is a diagram illustrating the sequence of a short-circuit operation of an inverter drive device according to the embodiment of the present disclosure.

### DETAILED DESCRIPTION

The inventors have found that a power conversion circuit that includes at least a switching element, and a control unit that detects a short-circuit state of the switching element and performs an off operation of the switching element based on the detection result, where the switching element includes a gallium oxide-based semiconductor, and the control unit controls the off operation of the switching element so that the time from short-circuit occurrence to the off operation is less than 1.4 μsec, may operate the power conversion circuit while suppressing the characteristic degradation of the gallium oxide-based semiconductor included in the switching element.

Embodiments of the present disclosure will be described below with reference to the accompanying drawings. In the following description, the same parts and components are designated by the same reference numerals. The present embodiment includes, for example, the following disclosures.

### [Structure 1]

A power conversion circuit including at least a switching element, and a control unit that detects a short-circuit state of the switching element and performs an off operation of the switching element based on a detection result, wherein the switching element includes a gallium oxide-based semiconductor, and the control unit controls the off operation of the switching element so that a time from occurrence of the short circuit to the off operation is less than 1.4 μsec.

### [Structure 2]

A power conversion circuit including at least a switching element, and a control unit that detects an abnormal state of the switching element and performs an off operation of the switching element based on a detection result, wherein the switching element includes a gallium oxide-based semiconductor, and the control unit controls the off operation of the switching element so that the gallium oxide-based semiconductor does not undergo a phase transition.

### [Structure 3]

A power conversion circuit including at least a switching element, and a control unit that detects an abnormal state of the switching element and performs an off operation of the switching element based on a detection result, wherein the switching element includes a gallium oxide-based semiconductor, and the control unit controls the off operation of the switching element so that a temperature of the gallium oxide-based semiconductor does not exceed 600° C.

### [Structure 4]

The power conversion circuit according to any one of [Structure 1] to [Structure 3], wherein the gallium oxide-based semiconductor is a corundum-structured gallium oxide-based semiconductor.

### [Structure 5]

The power conversion circuit according to [Structure 4], wherein the corundum-structured gallium oxide-based semiconductor includes α-Ga₂O₃ or a mixed crystal thereof.

### [Structure 6]

The power conversion circuit according to [Structure 4], wherein the corundum-structured gallium oxide-based semiconductor is α-Ga₂O₃.

### [Structure 7]

The power conversion circuit according to [Structure 1], wherein the control unit controls the off operation so that a time from occurrence of a short circuit to the off operation is 0.4 μsec or less.

### [Structure 8]

The power conversion circuit according to any one of [Structure 1] to [Structure 3], wherein the control unit includes a short-circuit detection circuit.

### [Structure 9]

The power conversion circuit according to any one of [Structure 1] to [Structure 3], wherein the switching element is a metal-oxide-semiconductor field-effect transistor (MOSFET).

### [Structure 10]

A control system comprising the power conversion circuit according to any of [Structure 1] to [Structure 3].

A power conversion circuit of an embodiment of the present disclosure is a power conversion circuit including at least a switching element, and a control unit that detects a short-circuit state of the switching element and performs an off operation of the switching element based on a detection result, in which the switching element includes a gallium oxide-based semiconductor, and the control unit controls the off operation of the switching element so that a time from occurrence of the short circuit to the off operation is less than 1.4 μsec. A power conversion circuit of another embodiment of the present disclosure is a power conversion circuit including at least a switching element, and a control unit that detects an abnormal state of the switching element and performs an off operation of the switching element based on a detection result, in which the switching element includes a gallium oxide-based semiconductor, and the control unit controls the off operation of the switching element so that the gallium oxide-based semiconductor included in the switching element does not undergo a phase transition. Furthermore, a power conversion circuit of another embodiment of the present disclosure is a power conversion circuit including at least a switching element, and a control unit that detects an abnormal state of the switching element and performs an off operation of the switching element based on a detection result, in which the switching element includes a gallium oxide-based semiconductor, and the control unit controls the off operation of the switching element so that a temperature of the gallium oxide-based semiconductor does not exceed 600° C.

The gallium oxide-based semiconductor (hereinafter also simply referred to as “semiconductor”) is not particularly limited as long as it is a semiconductor containing gallium oxide. The crystal structure of the semiconductor is also not particularly limited unless it interferes with the present disclosure. Examples of the crystal structure of the semiconductor include a corundum structure, a β-gallia structure, a hexagonal crystal structure (such as an & type structure, for example), an orthorhombic crystal structure (such as a k type structure, for example), a cubic crystal structure, and a tetragonal crystal structure. In the embodiment of the present disclosure, it is preferable that the crystal structure of the semiconductor is a corundum structure or a β-gallium structure, and it is more preferable that it is a corundum structure. In one embodiment of the present disclosure, even when the semiconductor is in a metastable phase (for example, when it has a corundum structure), it is possible to operate the circuit without the semiconductor undergoing a phase transition due to temperature rise. In this specification, the term “phase transition temperature” refers to a temperature at which the crystal structure of the semiconductor changes. For example, if the semiconductor is a gallium oxide-based semiconductor and has a metastable crystal structure (such as corundum structure, ¿-type, k-type, or the like), the crystal structure of the semiconductor will undergo a phase transition to the most stable crystal structure (β-type) at that temperature. The phase transition temperature may be, for example, 600° C. if the semiconductor is α-Ga₂O₃. The phase transition temperature may be, for example, 700° C. to 1000° C. if the semiconductor is α-(Al, Ga)₂O₃. Note that the phase transition temperature may be a temperature determined by experiments. If the semiconductor has a corundum structure, the semiconductor is not particularly limited as long as it includes a crystal or mixed crystal of gallium oxide with a corundum structure. In the embodiment of the present disclosure, if the semiconductor is a mixed crystal, it is preferable to contain at least corundum-structured gallium oxide as the major component. Suitable examples of the semiconductor being a mixed crystal include α-(Al, Ga)₂O₃, α-(Ir, Ga)₂O₃, and α-(In, Ga)₂O₃. Here, “containing corundum-structured gallium oxide as the major component” means that, for example, if the semiconductor is α-(Al, Ga)₂O₃ (mixed crystal of α-Ga₂O₃ and α-Al₂O₃), it is sufficient α-Ga₂O₃ is included in the semiconductor at the atomic ratio of 0.5 or more of gallium in all the metal elements contained in the semiconductor. In the embodiment of the present disclosure, the atomic ratio of gallium in all the metal elements contained in the semiconductor is preferably equal to or greater than 0.7 and is more preferably equal to or greater than 0.9. In the embodiment of the present disclosure, the semiconductor is preferably α-Ga₂O₃.

The switching element is not particularly limited unless it interferes with the present disclosure, and it may be a MOSFET or an IGBT. In addition, in the embodiment of the present disclosure, the switching element preferably includes a freewheeling diode. The freewheeling diode may be built into the switching element or may be external.

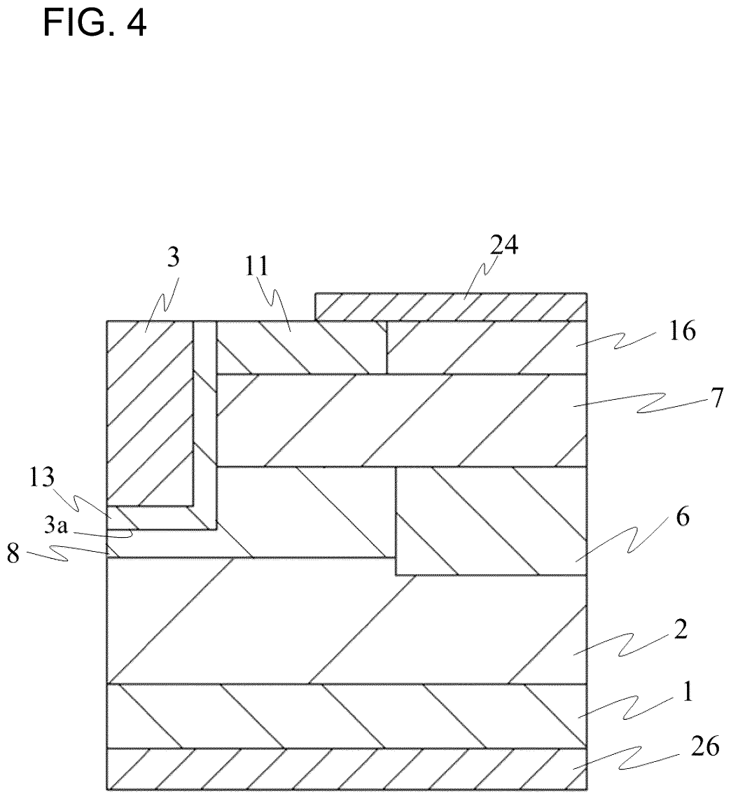

FIG. 4 illustrates a suitable example of the switching element. FIG. 4 illustrates a semiconductor device, which is a metal-oxide-semiconductor field-effect transistor (MOSFET). It includes an n+ type semiconductor layer (drain layer) 1, an n− type semiconductor layer (drift layer) 2, a p+ type semiconductor layer (deep p layer) 6, a p− type semiconductor layer (channel layer) 7, a current dispersion layer 8, an n+ type semiconductor layer (n+ source layer) 11, a gate insulating film 13, a gate electrode 3, a p+ type semiconductor layer 16, a source electrode 24, and a drain electrode 26. Note that the p+ type semiconductor layer (deep p layer) 6 is embedded in the n− type semiconductor layer 2 at a position that is at least partially deeper than a buried lower end portion 3a of the gate electrode 3. In addition, the current dispersion layer 8 is located directly beneath the gate electrode 3. In the ON state of the semiconductor device illustrated in FIG. 4, a voltage is applied between the source electrode 24 and the drain electrode 26, and when a positive voltage is applied to the gate electrode 3 with respect to the source electrode 24, a channel is formed at the interface between the p− type semiconductor layer 7 and the gate insulating film 13, turning the semiconductor on. In the OFF state, the voltage of the gate electrode 3 is set to 0V, which prevents the channel from being formed and the semiconductor is turned off.

In one embodiment of the present disclosure, the control unit detects the short-circuit state of the switching element, and controls the off operation of the switching element based on the detection result so that the time from the occurrence of the short circuit to the off operation is less than 1.4 μsec. In the embodiment of the present disclosure, the control of the off operation is not particularly limited as long as the time from the occurrence of the short circuit to the off operation (hereinafter also simply referred to as “off-operation time”) is less than 1.4 μsec. Note that in the embodiment of the present disclosure, when the control unit detects a short circuit of the switching element, it preferably performs control so that the time from the occurrence of the short circuit to the off operation is less than 1.4 μsec. In another embodiment of the present disclosure, the control unit detects an abnormal state of the switching element, and controls the off operation of the switching element based on the detection result to ensure that the temperature of the semiconductor does not exceed 600° C. An abnormal state refers to a state in which the electrical or thermal state of the switching element deviates from the predetermined normal state. Detection of an abnormal state is carried out using a known method. The control of the off operation is such that it may control the off operation so that the temperature of the semiconductor does not exceed 600° C. A known configuration may be used as the configuration and the like of the control circuit. As the method of off-operation control for not exceeding 600° C., more specifically, for example, there is a method of conducting simulations regarding the temperature rise during a short circuit as described later and calculating the relationship between the temperature rise during a short circuit and time, and then performing off-operation control so that the temperature does not exceed 600° C. during the off-operation time. In another embodiment of the present disclosure, the control unit detects an abnormal state of the switching element, and controls the off operation of the switching element based on the detection result so that the semiconductor does not undergo a phase transition. In this case, the control of the off operation suppresses the phase transition of the semiconductor by controlling the off operation so that the phase transition temperature of the semiconductor is not exceeded. The abnormal state may be a short-circuit state, or it may be a state where the temperature of the switching element is at or above a specific temperature (e.g., temperature about 30° C. lower than phase transition temperature). Note that the off-operation time is not particularly limited unless it interferes with the present disclosure. The gallium oxide-based semiconductor tends to have a short temperature rise time during a short circuit, as will be described later. Therefore, when detecting a short circuit and performing an off operation, the off-operation time is usually, preferably, 1.0 μsec or less. The off-operation time is preferably 0.5 μsec or less, more preferably 0.4 μsec or less, and most preferably 0.3 μsec or less. By setting such a desirable off-operation time, it is possible to improve the degree of freedom of the circuit operation while suppressing the degradation of the characteristics of the switching element.

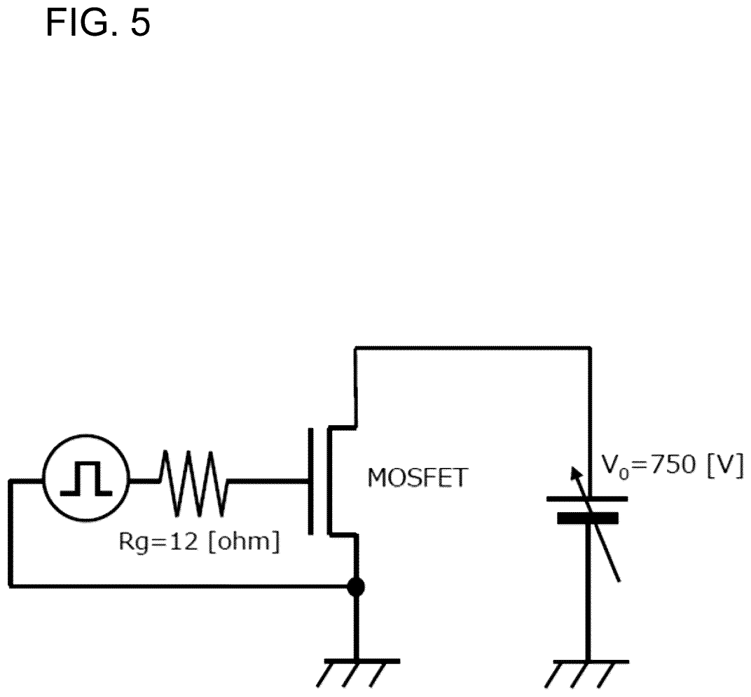

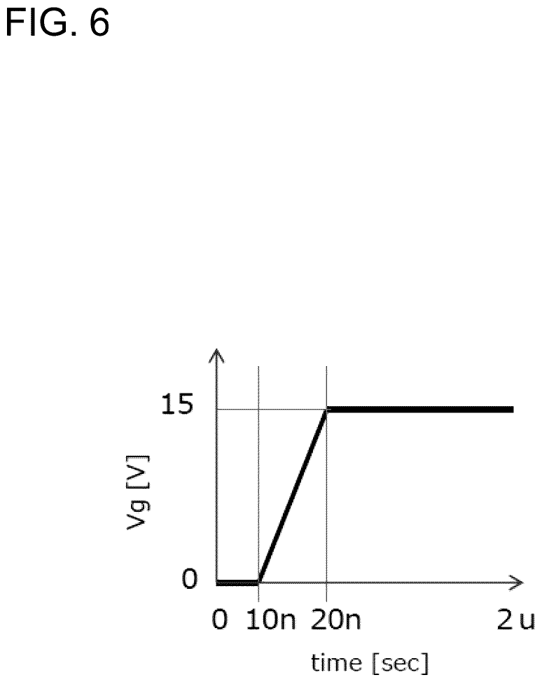

A simulation was conducted to compare the temperature rise during a short circuit when using SiC and Ga₂O₃ as the semiconductor material for a structure similar to the MOSFET illustrated in FIG. 4. The physical properties of SiC and Ga₂O₃ used in the simulation are as shown in Table 1. The simulation circuit is shown in FIG. 5, and the time variation of the gate voltage in gate voltage control is shown in FIG. 6. The simulation results showed that when using Ga₂O₃, it is necessary to perform the off operation from a short circuit more quickly (in less than at least 1.4 μsec) than when using SiC. The fact that gallium oxide-based semiconductors may reach such high temperatures during operation (particularly during short circuit) and that the temperature rises so quickly during a short circuit is a new finding from this simulation.

TABLE 1

| Item | SiC | Ga₂O₃ |
|---|---|---|
| Heat conductivity [W/cm · K] | 4.95 | 0.136 |
| Heat capacity [J/cm³ · K] | 2.18 | 2.92 |
| Intrinsic electron mobility [cm²/Vs] | 860 | 300 |
| Breakdown field strength [MV/cm] | 3.0 | 8.0 |
| Young's modulus [dyn/cm²] | 2.3 × 10¹² | 4.4 × 10¹² |
| Poisson's ratio | 0.17 | 0.3 |
| Coefficient of thermal expansion [K⁻¹] | 3.7 × 10⁻⁸ | 5.3 × 10⁻⁶ |

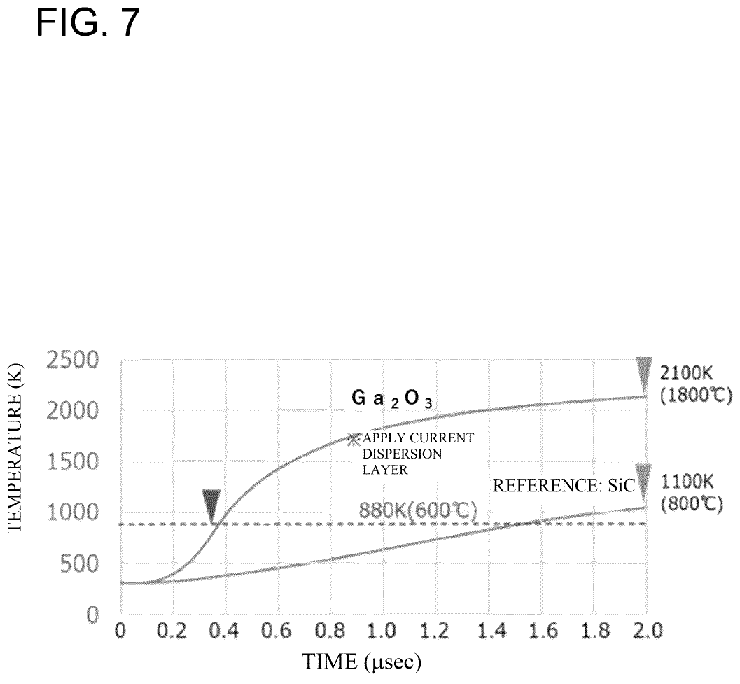

The simulation results for a drift layer thickness of 3.0 μm, a current dispersion layer depth of 1.0 μm, and a deep p-layer depth of 1.3 μm are illustrated in FIG. 7. FIG. 7 illustrates the relationship between the elapsed time and temperature after a short circuit occurs (from start of temperature rise) when applying the current dispersion layer. As can be seen from FIG. 7, in the case of Ga₂O₃, it is understood that the temperature reaches 600° C. after 0.4 μsec has elapsed since the short circuit. When the temperature of the switching element reaches a high temperature such as over 600° C., irreversible degradation occurs at the interface between the semiconductor and the electrode, or at the MOS interface (when the switching element is a MOSFET). More specifically, the degradation of the interface between the semiconductor and the electrode includes, for example, migration and oxidation of the electrode metal. Therefore, particularly when using a gallium oxide-based semiconductor for the current dispersion layer of a switching element, it is preferable for the control unit to control the off operation so that the time from short circuit occurrence to the off operation is 0.4 μsec or less. Note that the specific off-operation time to be set may be calculated by performing simulations according to the applicable circuit or device structure, or it may be calculated from the results of actual operation measurements.

Hereinafter, a power conversion circuit according to the embodiment of the present disclosure will be described in more detail with reference to the drawings. Note that modes of a short-circuit detection circuit in the power conversion circuit are not particularly limited unless they interfere with the present disclosure. Circuit configurations other than the short-circuit detection circuit shown below may be used if it is possible to perform the off-operation time within the time specified above or it is possible to perform the off operation in a range where the temperature of the gallium oxide-based semiconductor does not exceed 600° C.

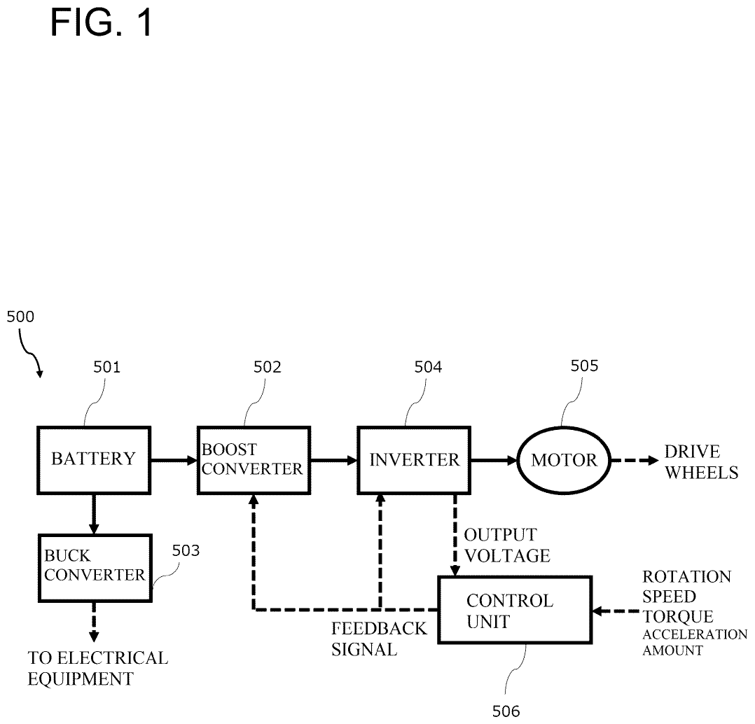

FIG. 1 is a block diagram of a control system 500 that includes a battery (power source) 501, a boost converter 502, a buck converter 503, an inverter 504, a motor (driven object) 505, and a control unit 506. These are mounted on an electric vehicle, for example. The battery 501 consists of a rechargeable battery such as a nickel-metal hydride battery and a lithium-ion battery, and it may store power through charging at a power supply station or regenerative energy during deceleration, while also being able to output the DC voltage required for the operation of the electric vehicle's drive system and electrical system. The boost converter 502 is, for example, a voltage conversion device equipped with a chopper circuit, which may boost a DC voltage of 200V, for example, supplied from the battery 501 to 650V, for example, through the switching operation of the chopper circuit, and output it to the drive system such as a motor. The buck converter 503 is also a voltage conversion device equipped with a chopper circuit, which may reduce a DC voltage of 200V, for example, supplied from the battery 501 to about 12V, for example, to output it to the electrical system, including power windows, power steering, and onboard electrical devices.

The inverter 504 converts the DC voltage supplied from the boost converter 502 into three-phase AC voltage through a switching operation and outputs it to the motor 505. The motor 505 is a three-phase AC motor that constitutes the drive system of the electric vehicle, driven by the three-phase AC voltage output from the inverter 504, and transmits its rotational driving force to the wheels of the electric vehicle through a transmission (not illustrated) or the like.

Meanwhile, using various sensors (not illustrated), actual measurements such as the wheel rotation speed, torque, and accelerator pedal depression amount (acceleration amount) are measured from the electric vehicle while driving, and these measurement signals are input to the control unit 506. At the same time, the output voltage value of the inverter 504 is also input to the control unit 506. The control unit 506 has the functions of a controller equipped with an arithmetic unit such as a central processing unit (CPU) and a data storage unit such as a memory. The control unit 506 generates a control signal using the input measurement signal and outputs it as a feedback signal to the inverter 504, thereby controlling the switching operation of the switching element. As a result, the AC voltage supplied by the inverter 504 to the motor 505 is instantaneously corrected, allowing for precise execution of the driving control of the electric vehicle, thereby achieving safe and comfortable operation of the electric vehicle. Note that it is also possible to control the output voltage to the inverter 504 by providing a feedback signal from the control unit 506 to the boost converter 502. The embodiment of the present disclosure is preferable in that the control unit 506 has a short-circuit detection circuit, which allows for a quicker off operation.

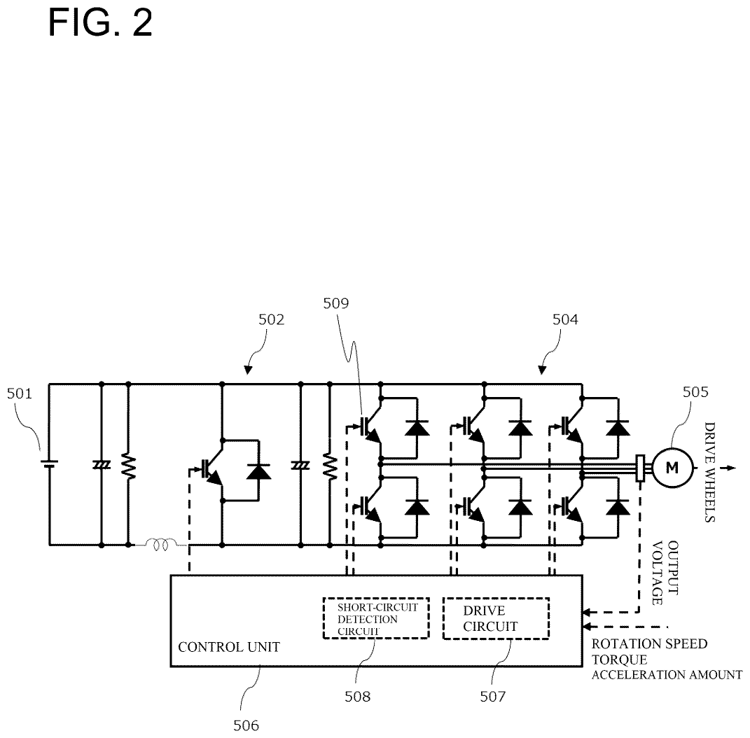

FIG. 2 illustrates a circuit configuration excluding the buck converter 503 in FIG. 1, that is, a circuit configuration that only illustrates the configuration for driving the motor 505. The corundum-structured gallium oxide-based semiconductor according to the embodiment of the present disclosure is used, for example, in a switching element 509 illustrated in FIG. 2. The switching element 509 in FIG. 2 is an insulated gate bipolar transistor (IGBT), but in the embodiment of the present disclosure, the switching element may be a MOSFET. Note that in the circuit of FIG. 2, the current is stabilized by interposing an inductor (such as coil) into the output of the battery 501, and the voltage is stabilized by interposing capacitors (such as electrolytic capacitors) between the battery 501, the boost converter 502, and the inverter 504.

In addition, as indicated by the dotted line in FIG. 2, the control unit 506 includes a drive circuit 507 and a short-circuit detection circuit 508. The drive circuit includes a storage unit consisting of an arithmetic unit and a non-volatile memory (not illustrated). The signal input to the drive circuit is given to the arithmetic unit, which generates a feedback signal by performing the necessary calculations. In addition, the storage unit temporarily holds the calculation results from the arithmetic unit and accumulates physical constants and functions or the like necessary for drive control in the form of tables, outputting them to the arithmetic unit as needed. The arithmetic and memory units may adopt known configurations, and their processing capabilities or the like may also be selected arbitrarily.

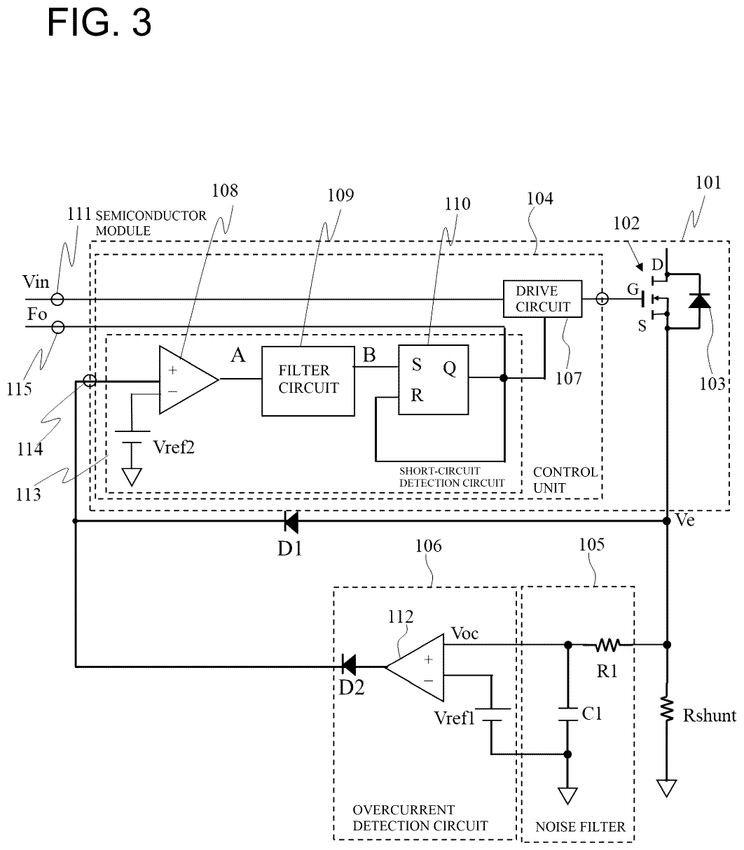

FIG. 3 is a diagram for schematically describing an inverter part and its control unit as the inverter drive device in FIG. 2. The inverter drive device in FIG. 3 is equipped with a switching element 102, a freewheeling diode 103, and a control unit 104. Additionally, a shunt resistor Rshunt, a noise filter 105, an overcurrent detection circuit 106, and a diode D1 are provided. The control unit 104 has a drive circuit 107, a comparator 108, a filter circuit 109, and an SR latch circuit 110. In FIG. 3, an example is illustrated where the switching element 102, the freewheeling diode 103, and the control unit 104 are provided inside a semiconductor module 101, but the embodiment of the present disclosure is not limited to such a configuration.

The drive circuit 107 drives the switching element 102 according to an input voltage Vin input from the outside via a terminal 111. A MOSFET is used as the switching element 102. The freewheeling diode 103 recirculates current when the switching element 102 is OFF.

The shunt resistor Rshunt is connected between a source S of the switching element 102 and GND. The shunt resistor Rshunt is a current detection unit that generates a voltage signal Ve corresponding to the current flowing through the switching element 102. Note that as the current detection unit, other current detection means such as Hall elements or current transformers may be used instead of the shunt resistor Rshunt. In the case of the switching element 102 equipped with a current sensing element, the sense current may flow through a current detection resistor to detect the current.

The noise filter 105 is an RC filter that has a resistor R1 and a capacitor C1. The noise filter 105 removes noise superimposed on the voltage signal Ve.

The overcurrent detection circuit 106 has a comparator 112 and a diode D2. An output voltage Voc of the noise filter 105 is input to the + terminal of the comparator 112. A first threshold Vref1 is input to the − terminal of the comparator 112. The voltage output from the comparator 112 via the diode D2 is an overcurrent detection signal. That is, when the voltage signal Voc input from the noise filter 105 exceeds the first threshold Vref1, the overcurrent detection circuit 106 determines that an overcurrent has occurred and outputs an overcurrent detection signal.

A short-circuit detection circuit 113 has the comparator 108, the filter circuit 109, and the SR latch circuit 110. The voltage signal Ve is input to the + terminal of comparator 108 via the diode D1 and a terminal 114. The overcurrent detection signal is also input to the + terminal of the comparator 108 via the terminal 114. A second threshold Vref2 is input to the − terminal of the comparator 108. The second threshold Vref2 is set to a value higher than the first threshold Vref1. In addition, when an overcurrent is detected, the voltage value of the overcurrent detection signal output from the overcurrent detection circuit 106 is greater than the second threshold Vref2. An output voltage A of the comparator 108 is input to the filter circuit 109. An output voltage B of the filter circuit 109 is input to the S terminal of the SR latch circuit 110, and an error signal Fo is output from the Q terminal. Therefore, the short-circuit detection circuit 113 outputs the error signal Fo when it receives an overcurrent detection signal from the overcurrent detection circuit 106, or when the voltage signal Ve received without passing through the noise filter 105 exceeds the second threshold Vref2. Note that the overcurrent detection signal may also be directly input to the filter circuit 109 or the SR latch circuit 110 without passing through the comparator 108. In that case, it is necessary to add a terminal for inputting the overcurrent detection signal from the outside of the semiconductor module 101 to the inside.

The error signal Fo is input to the R terminal of the SR latch circuit and the drive circuit 107, and is output to the outside of the semiconductor module 101 via a terminal 115. Therefore, when the inverter drive device determines an overcurrent or short circuit, it outputs the error signal Fo to the outside of the semiconductor module 101. In addition, when the drive circuit 107 receives the error signal Fo, it cuts off a gate signal Vg of the switching element 102 and stops the drive of the switching element 102.

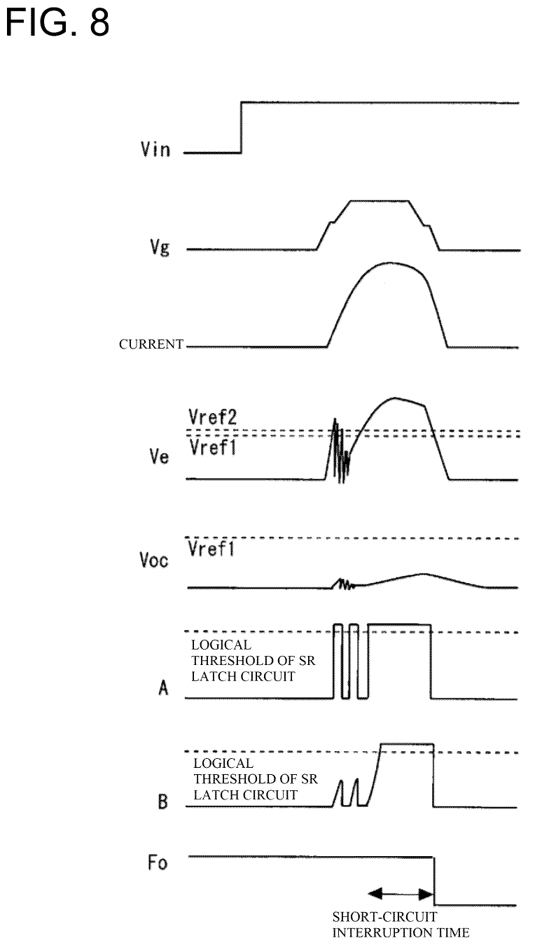

FIG. 8 is a diagram illustrating the sequence of the short-circuit operation of the inverter drive device according to the embodiment of the present disclosure. Even if a large current flows through the switching element 102 due to an abnormal operation of the inverter drive device or the like, noise occurs in the voltage signal Ve immediately after the current flows, just like during normal operation. Then, the voltage signal Ve increases to follow the current waveform. Due to the low responsiveness of the noise filter 105, the time for the voltage signal Voc to reach the first threshold Vref1 is delayed. Meanwhile, the short-circuit detection circuit 113 detects a short circuit based on the electric signal Ve received without passing through the noise filter 105, making it more responsive than the overcurrent detection circuit 106, and allowing for rapid short-circuit detection. Note that the short-circuit interruption time in FIG. 8 is the time from when a short circuit occurs and the short circuit is detected until the gate signal Vg of the switching element 102 is interrupted.

In the embodiment described above, an example using a MOSFET as the switching element is used, but an IGBT may be used instead of the MOSFET. In addition, the configuration of detection circuits and the like to achieve a specific off-operation time (e.g., 0.4 μsec) is not limited to the embodiment described above. In the embodiment of the present disclosure, it is preferable to use the drive circuit described in Japanese Patent Laid-Open No. 2021-57976. In the embodiment described above, an example is illustrated in which a short-circuit state is detected and the switching element is controlled to turn off quickly based on the detection result; however, the present disclosure is not limited to such an example. For example, a state in which the temperature of the switching element is at or above a specific temperature may be detected as an abnormal state, and based on the detection result, the off operation of the switching element may be performed. In this case, the detection of the temperature of the switching element may be performed using a known configuration. For example, the temperature of the switching element is detected using a known temperature detection unit (such as temperature sensor), and based on the detection result, the off operation is controlled using a known control unit.

In addition, the type of the power conversion circuit is not particularly limited unless it interferes with the present disclosure. In the embodiment of the present disclosure, the power conversion circuit may be an AC-AC conversion circuit, a DC-AC conversion circuit, or a DC-DC conversion circuit.

Note that it is also possible to combine multiple embodiments of the present disclosure, apply some components to other embodiments, increase or decrease the number of certain components, and combine them with other known technologies. Unless it interferes with the present disclosure, it is also possible to modify the configuration by omitting some parts or the like, and such modifications also belong to the embodiments of the present disclosure.

The power conversion circuit and control system according to the embodiment of the present disclosure may be used in various fields such as electronic components and electrical equipment components, optical and electrophotographic related devices, lighting equipment, power supply devices, automotive electrical equipment, industrial power converters, industrial motors, infrastructure equipment (e.g., power facilities in buildings, factories, and the like, communication equipment, traffic control devices, water supply and sewage treatment facilities, system equipment, labor-saving devices, trains, and the like), and home appliances (e.g., refrigerators, washing machines, personal computers, LED lighting equipment, video equipment, audio equipment, and the like).

The embodiments of the present disclosure are exemplified in all respects, and the scope of the present disclosure includes all modifications within the meaning and scope equivalent to the scope of claims.

### REFERENCE SIGNS LIST

1 n+ type semiconductor layer
2 n− type semiconductor layer (drift layer)
3 Gate electrode
3a Buried lower end portion
6 p+ type semiconductor layer (deep p layer)
7 p− type semiconductor layer (channel layer)
8 Current dispersion layer
11 n+ type semiconductor layer
13 Gate insulating film
16 p+ type semiconductor layer
24 Source electrode
26 Drain electrode
101 Semiconductor module
102 Switching element
103 Freewheeling diode
104 Control unit
105 Noise filter
106 Overcurrent detection circuit
107 Drive circuit
108 Comparator
109 Filter circuit
110 SR latch circuit
111 Terminal
112 Comparator
113 Short-circuit detection circuit
114 Terminal
115 Terminal
500 Control system
501 Battery (power source)
502 Boost converter
503 Buck converter
504 Inverter
505 Motor (drive target)
506 Control unit
507 Drive circuit
508 Short-circuit detection circuit
509 Switching element

What is claimed is:

1. A power conversion circuit comprising at least a switching element, and a control unit that detects a short-circuit state of the switching element and performs an off operation of the switching element based on a detection result, wherein the switching element includes a gallium oxide-based semiconductor, and the control unit controls the off operation of the switching element so that a time from occurrence of the short circuit to the off operation is less than 1.4 μsec.

2. A power conversion circuit comprising at least a switching element, and a control unit that detects an abnormal state of the switching element and performs an off operation of the switching element based on a detection result, wherein the switching element includes a gallium oxide-based semiconductor, and the control unit controls the off operation of the switching element so that the gallium oxide-based semiconductor does not undergo a phase transition.

3. A power conversion circuit comprising at least a switching element, and a control unit that detects an abnormal state of the switching element and performs an off operation of the switching element based on a detection result, wherein the switching element includes a gallium oxide-based semiconductor, and the control unit controls the off operation of the switching element so that a temperature of the gallium oxide-based semiconductor does not exceed 600° C.

4. The power conversion circuit according to claim 1, wherein the gallium oxide-based semiconductor is a corundum-structured gallium oxide-based semiconductor.

5. The power conversion circuit according to claim 4, wherein the corundum-structured gallium oxide-based semiconductor includes α-Ga₂O₃ or a mixed crystal thereof.

6. The power conversion circuit according to claim 4, wherein the corundum-structured gallium oxide-based semiconductor is α-Ga₂O₃.

7. The power conversion circuit according to claim 1, wherein the control unit controls the off operation so that a time from occurrence of a short circuit to the off operation is 0.4 μsec or less.

8. The power conversion circuit according to claim 1, wherein the control unit includes a short-circuit detection circuit.

9. The power conversion circuit according to claim 1, wherein the switching element is a metal-oxide-semiconductor field-effect transistor (MOSFET).

10. A control system comprising the power conversion circuit according to claim 1.
